(19) United States
(12) Patent Application Publication
(10) Pub. No.: US 2006/0169715 A1
(43) Pub. Date: Aug. 3, 2006

(54) Controller-based management of a fluid dispensing system

(76) Inventors: Jorg Emmendorfer, Wuppertal (DE); Knut Richter, Freising (DE); Rudolph Till, Lauf (DE)

Correspondence Address: SHUMAKER & SIEFFERT, P. A., 8425 SEASONS PARKWAY, SUITE 105, ST. PAUL, MN, 55125, US

(21) Appl. No.: 11/264,617

(22) Filed: Oct. 31, 2005

Related U.S. Application Data
(63) Continuation-in-part of application No. 10/985,302, filed on Nov. 9, 2004.

(51) Int. Cl. B67D 5/08; B67D 1/08

(52) U.S. Cl. 222/59; 222/148

(57) ABSTRACT

A beverage dispensing system having control-based functionality for managing a beverage dispensing process and a cleaning process for fluid dispensing system is disclosed. The beverage dispensing system has one or more beverage containers that supply beverage(s) to beverage line(s), which in turn, supply the beverage(s) to dispense unit(s), or tap(s). Each beverage container includes a beverage port through which a beverage is output to an associated beverage line for communication to an associated tap. A coupler is affixed to the container and interfaces the associated beverage line to the beverage port on the container. The coupler provides functionality for not only enabling the beverage dispensing process, but also facilitates the cleaning process by providing an interface for water and cleaning chemicals. Various configurations of the beverage dispensing system are disclosed including a tank valve configuration and a configuration in which containers are connected in series. The beverage dispensing system is adapted to accommodate for controller-based management of these systems as well.

### RELATED APPLICATIONS

This application is a continuation-in-part of U.S. patent application Ser. No. 10/985,302, filed on Nov. 9, 2004 and entitled “CHEMICAL DISPENSE SYSTEM FOR CLEANING COMPONENTS OF A FLUID DISPENSING SYSTEM,” which is hereby incorporated by reference in its entirety.

Furthermore, this application is related to subject matter disclosed in U.S. patent application for CONTROLLER-BASED MANAGEMENT OF A FLUID DISPENSING SYSTEM, Ser. No. (Attorney Docket No. 00163.2104-US-01), U.S. patent application for MONITORING OPERATION OF A FLUID DISPENSING SYSTEM, Ser. No. (Attorney Docket No. 00163.2001-US-12) and U.S. patent application for CLEANING PROCESSES FOR A FLUID DISPENSING SYSTEM, Ser. No. (Attorney Docket No. 00163.2001-US-13), each of which are filed on even date herewith and hereby incorporated by reference by their entirety.

### TECHNICAL FIELD

The present invention generally relates to fluid dispensing systems, and more particularly to managing operation of fluid dispensing systems.

### BACKGROUND

Conventional beer dispensing systems include beer lines through which beer is supplied from kegs to taps, which are operable to dispense the beer to drinking containers such as steins, pilsner glasses and frosty mugs. When a tap is opened, beer is dispensed from the system as a pressure is exerted into the associated keg thereby forcing beer out of the keg and into a beer line fluidly coupled to the keg by way of a keg coupler. The pressure is typically supplied by a gas source such as, for example, a tank of carbon dioxide or nitrogen or a gas blender providing a mixture of gases. Regardless of the type of gas source employed, the keg coupler interfaces the applied pressure to the keg, which is thus pressurized such that any beer contained therein is pushed up to the beer lines through the coupler. The associated tap at the other end of the beer line from the keg may then be opened thereby allowing beer to be dispensed therefrom.

Control over operation of such conventional beer dispensing systems is purely a manual process. As such, bartenders and restaurant managers typically spend countless hours each month performing various maintenance and operating tasks such as, for example, switching between kegs, monitoring beer usage and estimating future demand figures. Further complicating management over conventional beer dispensing systems is that many bars and restaurants require an increased capacity of beer from that typically provided by conventional kegs. Various changes in the above-described configuration have been employed to accommodate increased capacity demands such as, for example, the use of increased capacity vessels (i.e., tank valves) in place of kegs and connecting kegs in series with one another on a single beer line. Though manual management of these systems is commonly adapted to accommodate for such configuration changes, these systems still require as much, if not more, periodic oversight and maintenance as with conventional systems.

In addition to standard operating tasks, beer dispensing systems require periodic cleaning. Conventional cleaning approaches involve the use of portable chemical dispense systems. In this regard, a cleaning technician will manually disconnect the beer lines from each individual keg coupler and then apply cleaning chemicals to the beer lines with the taps in the open position such that the chemicals will be distributed through the lines. Thus, a technician is required to disconnect the beer line from each keg in a beer dispensing system being cleaned, which is a daunting task indeed. Because current approaches require so much time and effort on part of the cleaning technicians, beer dispensing systems are commonly cleaned on rather lengthy time intervals. Such lengthy cleaning intervals tend to facilitate the collection of bacteria and soil in the beverage lines thereby risking contamination with the beer and potentially making it somewhat unsafe for human consumption.

While only beer dispensing systems are described above, these drawbacks are commonly known to exist with respect to other types of fluid dispensing systems. As such, it is against this background that the present invention has been made relative to all types of fluid dispensing systems.

### SUMMARY OF THE INVENTION

The present invention is generally directed to a computer-implemented approach to managing operation of a fluid dispensing system. Such management may be directed to fluid dispensing processes or cleaning processes thereby providing automated control over a wide range of system functionality. To accomplish this, the fluid dispensing system includes a controller operable to receive and track information regarding operation of the system relative to both processes.

In an embodiment, the fluid dispensing system includes fluid containers that are connected in series with one another to provide a fluid to a single beverage line. Management over this fluid dispensing system is administered according to an embodiment by a method that involves receiving sensed information indicating an actual volume of fluid remaining in a first of the plurality of series-connected fluid containers. Once received, this sensed information is analyzed against a predetermined threshold parameter to determine whether the actual volume of fluid contained in the first series-connected fluid container is less than the predetermined threshold parameter. If so, the method involves disabling flow of the fluid from the first series-connected fluid container to the fluid line and enabling flow of the fluid from a second of the plurality of series-connected fluid containers to the fluid line. Therefore, as one fluid container empties, another fluid container is employed to provide a substantially continuous supply of fluid to the fluid line. Consistent with above, the fluid may be a beverage such as, for example, beer.

In another embodiment, management over fluid dispensing system having series-connected fluid container is administered by a system having, in addition to the controller, a flow sensor that communicates information regarding flow of fluid in the system to the controller for analysis thereby. Additionally, the system includes a first coupler attached to a first of the plurality of series-connected fluid containers as well as a second coupler attached to a second of the plurality of series-connected fluid containers. The first coupler is controllable by the controller to enable and disable flow of the fluid from the first series-connected fluid container to the output fluid line. Likewise, the second coupler is controllable by the controller to enable and disable flow of the fluid from the second series-connected fluid container to the output fluid line. In addition, the second coupler is fluidly connected to the first coupler by an intermediate fluid line such that fluid supplied to the first container is communicated to the output fluid line by way of the intermediate fluid line and the second coupler.

Continuing with the system embodiment in the preceding paragraph, the flow sensor monitors flow of the fluid in the intermediate fluid line and transmits measured flow readings to the controller. The controller determines whether any of the measured flow readings fail to satisfy a predetermined threshold value, and if so, instructs the first coupler to disable flow of the fluid from the first series-connected fluid container to the intermediate fluid line. Additionally, in this case, (i.e., a measured flow reading failing to satisfy the predetermined threshold value), the controller instructs the second coupler to enable flow of the fluid from the second series-connected fluid container to the output fluid line.

Application of a cleaning process to a fluid dispensing system configured in this manner (i.e., with series-connected containers) is accomplished in an embodiment by disabling flow of the fluid to the fluid line from both the first series-connected container and the second series-connected fluid container. Then, the cleaning process may be initiated and, in another embodiment, is so initiated by controlling fluid ports on both the first and the second series-connected fluid containers such that communication of the fluid from either fluid port to the fluid line is precluded.

In accordance with yet another embodiment, the fluid dispensing system includes a fluid container from which a fluid is supplied to a plurality of dispense units via a plurality of fluid lines. In this embodiment, fluid is output from the fluid container and provided to a splitter that supplies each of the plurality of fluid lines with the fluid. Management over this fluid dispensing system involves positioning a first controllable valve in a first fluid line and a second controllable valve in a second fluid line. Initially, for fluid dispensing purposes, both the first controllable valve and the second controllable valve are enabled such that fluid is allowed to flow from the splitter to the first and second fluid lines. In response to receipt of an instruction to clean of the first fluid line, but not the second fluid line, the first controllable valve is disabled such that fluid is precluded from flowing between the splitter and the first fluid line. Accordingly, the first fluid line is prepared for cleaning. Meanwhile, the second controllable valve is maintained in the enabled mode such that fluid is continuously operable to flow between the splitter and the second fluid line during cleaning of the first fluid line.

These and various other features as well as advantages, which characterize the present invention, will be apparent from a reading of the following detailed description and a review of the associated drawings.

### BRIEF DESCRIPTION OF THE DRAWINGS

FIG. 1 is a fluid dispensing system having an integrated controller-based chemical dispense system for cleaning components of the fluid dispensing system in accordance with an embodiment of the present invention.

FIG. 2 depicts a gas-fluid junction and a coupler, and an exemplary connection therebetween for use in the fluid dispensing system shown in FIG. 1.

FIG. 3 illustrates in block diagram form a system for managing operation of a fluid dispensing system, such as the fluid dispensing system of FIG. 1, in accordance with various embodiments of the present invention.

FIG. 4 illustrates the fluid dispensing system of FIG. 1 as configured in accordance with an embodiment of the present invention to include a plurality of fluid containers that share a single fluid line.

FIG. 5 illustrates a device (i.e., “fob stop”) for controlling operation of a fob installed in a fluid line of a fluid dispensing system in accordance with an embodiment of the present invention.

FIG. 6 is a flow diagram illustrating operational characteristics for managing operation of the fluid dispensing system shown in FIG. 4 in accordance with an embodiment of the present invention.

FIG. 7 is a flow diagram illustrating operational characteristics according to an embodiment of the present invention in which at least one fob is controlled using the fob stop shown in FIG. 6.

FIG. 8 illustrates the fluid dispensing system of FIG. 1 as configured in accordance with an embodiment of the present invention to include a fluid container that is not operable for attachment to the coupler shown in FIG. 2.

FIG. 9 is a flow diagram illustrating operational characteristics for managing operation of the fluid dispensing system shown in FIG. 8 in accordance with an embodiment of the present invention.

FIG. 10 depicts a general-purpose computer that may be configured to implement logical operations of the present invention in accordance with an embodiment thereof.

### DETAILED DESCRIPTION

The present invention and its various embodiments are described in detail below with reference to the figures. When referring to the figures, like structures and elements shown throughout are indicated with like reference numerals. Objects depicted in the figures that are covered by another object, as well as the reference annotations thereto, are shown using dashed lines.

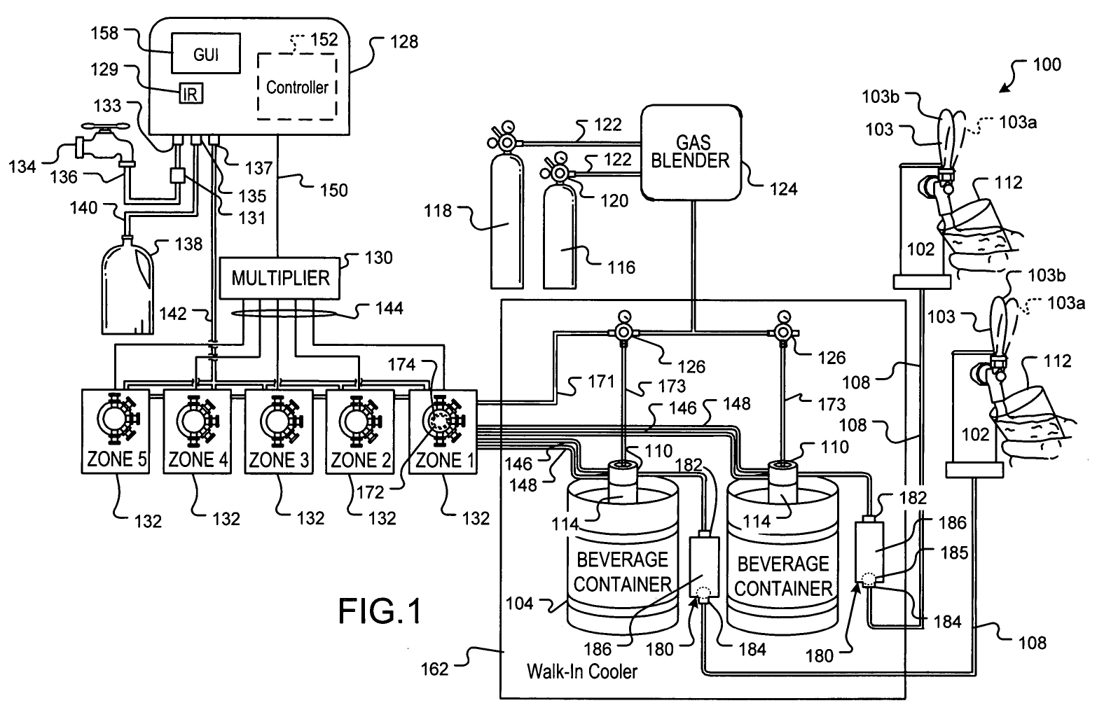

The present invention is generally directed to managing operation of a fluid dispensing system, and in accordance with a specific embodiment, a beverage dispensing system (e.g., 100 shown in FIG. 1). The beverage dispensing system 100 administers beverage-dispensing processes during which beverages are provided to dispense units 102, or “taps,” for dispensing to cups, mugs, glasses or steins for consumption by a user. Embodiments of the present invention relate to monitoring and controlling these dispensing processes in automated fashion as described in greater detail below with reference to the figures.

Also, in an embodiment, the present invention involves monitoring and controlling a chemical dispense system for use in cleaning the beverage dispensing system 100, as described in parent application Ser. No. 10/985,302 and U.S. patent application Ser. No. 11/142,995 (filed Jun. 1, 2005), which is also entitled “CHEMICAL DISPENSE SYSTEM FOR CLEANING COMPONENTS OF A FLUID DISPENSING SYSTEM” and, like parent application Ser. No. 10/985,302, is hereby incorporated by reference herein by its entirety. The chemical dispense system is integrated into the beverage dispensing system 100, and thus, referred to as an “in-line” cleaning system. In operation, the in-line cleaning system administers a “cleaning process” to the beverage dispensing system 100 in which the various fluid-carrying lines and components are cleaned in accordance with embodiments described in the above-referenced patent applications. With that said, the beverage dispensing system 100 is described generally below in accordance with embodiments of the present invention to include the in-line cleaning system and, thus, the present invention is applicable to monitor and control not only beverage dispensing processes, but cleaning processes as well. Those of skill in the art will therefore recognize applicability of the various embodiments of the present invention to both a stand-alone beverage dispensing system 100 and also a beverage dispensing system 100 having an in-line cleaning system.

While many different types of beverages and beverage dispensing systems are contemplated within the scope of the present invention, the beverage dispensing system 100 is described as being a beer dispensing system used to dispense beer to a bar area of a restaurant. Indeed, those of skill in the art will appreciate that the beverage dispensing system 100 is operable to dispense any other type of beverage, such as, for example, soda, juices, coffees and dairy products. Even further, the beverage dispensing system 100 may be utilized to dispense fluids other than beverages such as, for example, paint.

With the above-described environment in mind, FIG. 1 shows a beverage dispensing system 100 in accordance with an embodiment of the present invention. The beverage dispensing system 100 dispenses different labels of beer through individual dispense units 102, as shown in FIG. 1 in the form of conventional beer taps. The dispense units 102 include handles 103 that may be toggled between an “off” position 103b and an “on” position 103a, the latter of which is shown using dashed lines. Alternatively, the position of the handles 103 may be controlled electronically or pneumatically. Regardless of the implementation, while the handles 103 are in the “off” position 103b, the dispense units 102 preclude the flow of beer therefrom. Conversely, while the handles 103 are in the “on” position 103a, the dispense units 102 enable the flow of beer therefrom and preferably to some form of drinking article, such as a stein or mug 112. To illustrate embodiments of the present invention, the dispense units 102 are shown in FIG. 1 with the handles 103 in the “on” position 103a.

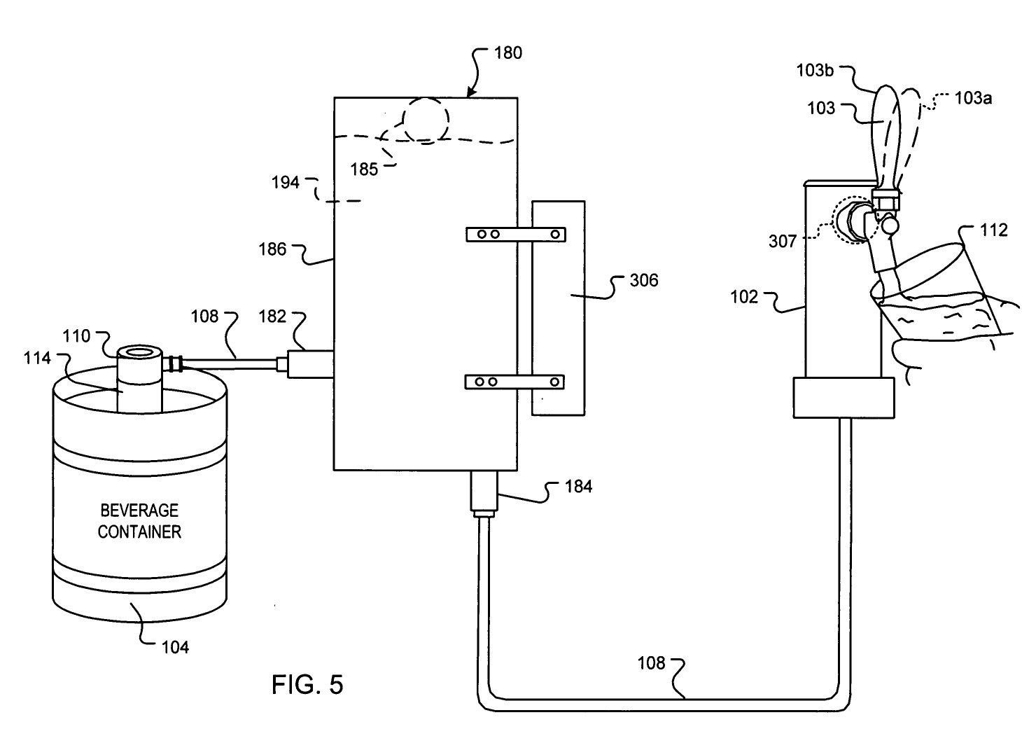

Prior to being dispensed, the various labels of beer, which are hereinafter referred to generally as beverages, are contained in beverage containers 104. The beverage containers 104 are illustrated in FIG. 1 as being conventional-sized kegs in accordance with an embodiment of the present invention. However, any other type and size of container (e.g., tanks, bag-in-box-systems) from which a beverage may be supplied will suffice, as shown in FIG. 5 and described in connection therewith. Whereas the dispense units 102 are preferably located in the bar area, the beverage containers 104 are stored in a cooling room, such as walk-in cooler 162, in order to direct and maintain the temperature of the beverages at a desired temperature.

Each dispense unit 102 is fluidly connected to a beverage container 104 by a beverage line 108. In accordance with an embodiment, each beverage line 108 includes a fob detector 180 (i.e., “fob”) integrated therein. Generally speaking, a fob 180 is device that detects the absence of beverages in the beverage line 108 into which it is installed and precludes further flow through the line 108 until a beverage is subsequently detected. Fobs 180 are therefore used to overcome problems realized when an associated beverage container 104 empties and any remaining beverage therein is forced out of the container 104 as a foamy substance. As is known to those skilled in the art, a fob 180 is constructed of an enclosed chamber 186 having an internal float 185 (shown in position when the fob 180 is devoid of beverage).

The enclosed chamber 186 is fluidly coupled to the associated beverage line 108 by way of a beverage input port 182 and a beverage output port 184. As beverage flows through the associated beverage line 108, the internal float 185 floats within the chamber 186 based on conventional buoyancy principles. As the associated beverage container 104 empties, gas applied to the container 104 begins to fill the beverage line 108 thereby terminating the buoyancy effect within the chamber 186, which causes the internal float 185 to drop within the chamber 186 and seal off the beverage output port 184, as shown in FIG. 1. As a result, any foamy substance accompanying the gas is not allowed to pass to the associated dispense units 102.

After the emptied beverage container 104 is replaced or, alternatively, replenished, beverage once again flows through the associated beverage line 108. Consequently, beverage begins to fill the chamber 186 thereby causing the internal float 185 to float therein and terminate the seal over the beverage output port 184. Beverage is then allowed to flow to and through the associated dispense unit 102 for dispensing to the mug 112. In some cases, the internal float 185 may be stuck in beverage output port 184 even with the chamber 186 filled with beverage and, as such, those of skill in the art should appreciate that the fob 180 includes functionality for manually removing the internal float 185 from the beverage output port 184.

Each beverage line 108 is connected to an associated beverage container 104 by a coupler 110. The couplers 110 are affixed to beverage ports 114 on the associated beverage containers 104 through which the beverages are output for direction by the couplers 110 to the associated beverage lines 108. Each coupler 110 provides functionality for opening the beverage port 114 to which the coupler 110 is affixed and introducing a pressure into the associated beverage container 104 to force the beverage contained therein through the beverage port 114 and to the associated beverage line 108. The connection provided by the coupler 110 between the beverage port 114 and the beverage line 108 is preferably air tight, and thereby operable to force the beverage through the associated beverage line 108 and to the associated dispense unit 102. Depending on the position of the dispense unit 102, dispensing of the beverage from the unit 102 is either precluded (i.e., handle 103 in “off” position 103b) or enabled (i.e., handle 103 in “on” position 103a).

The pressure used to force beverages from the beverage containers 104 to the dispense units 102 via the beverage lines 108 is supplied to the couplers 110 from one or more pressure sources, e.g., 116 and 118. These pressure sources 116, 118 are shown in accordance with an embodiment as being compressed gas tanks having different reference numerals (i.e., 116 and 118) to differentiate between the different types of gas contained by each. For example, pressure source 116 includes carbon dioxide and pressure source 118 includes nitrogen in accordance with an exemplary embodiment.

Each gas tank 116 and 118 includes a primary regulator 120. The primary regulators 120 regulate the flow of gas from the gas tanks 116, 118 to a gas blender 124 via gas lines 122. The gas blender 124 blends the gases from the gas tanks 116 and 118 and provides a mixed gas compound to secondary regulators 126. Each of the secondary regulators 126 regulate the flow of the mixed gas compound from the gas blender 124 to individual couplers 110, thereby providing the requisite pressure to force the beverages from the beverage containers 104 to the dispense units 102. As such, there exists a 1:1 correlation between secondary regulators 126 and beverage containers 104. In accordance with alternative embodiments, a single secondary regulator 126 may regulate the flow of the mixed gas compound to more than one beverage container 104.

As described above in accordance with an embodiment of the present invention, the beverage dispensing system 100 includes an in-line cleaning system that administers a cleaning process applied to the beverage dispensing system 100. The in-line cleaning system encompasses various components of the beverage dispensing system 100 such as, without limitation, the couplers 110, as well as a control system 128, a zone controller 130 (optional), various data communications lines (e.g., 150 and 144), various substance communication lines (e.g., 146 and 148) and gas-fluid junctions 132, each of which are shown generally in block diagram form in FIG. 1.

The control system 128 is a controller-based system that manages the overall administration of cleaning processes applied to the beverage dispensing system 100. In this regard, the beverage dispensing system 100 includes a controller 152 (internal to the control box 128) that controls and monitors various tasks administered by the control system 128 in performance of beverage dispensing and system cleaning processes. In accordance with an embodiment, the controller 152 is a PLC (programmable logic controller) providing hardened I/O (inputs/outputs) for the control system 128.

The control system 128 also includes one or more display devices or modules, such as, without limitation, a graphical user interface (GUI) 158. The GUI 158 allows a user to monitor and control operation of the control system 128 through a touch screen interface. For instance, the GUI 158 may present information to a user that represents the operational status of the beverage dispensing system 100 in performance of beverage dispensing processes or the in-line cleaning system in performance of cleaning processes. Such information may be in the form of icons selectable to control either process. For example, the GUI 158 may include icons selected by a user to initiate or suspend either the dispensing process or the cleaning process. Furthermore, the GUI 158 may present to the user a selection screen that enables the user to control aspects of the cleaning process by defining or modifying the phases of the cleaning process or the amount of time that each phase is to be administered. In addition, the GUI 158 may function as a security mechanism for limiting access to the control system 128 to authorized users.

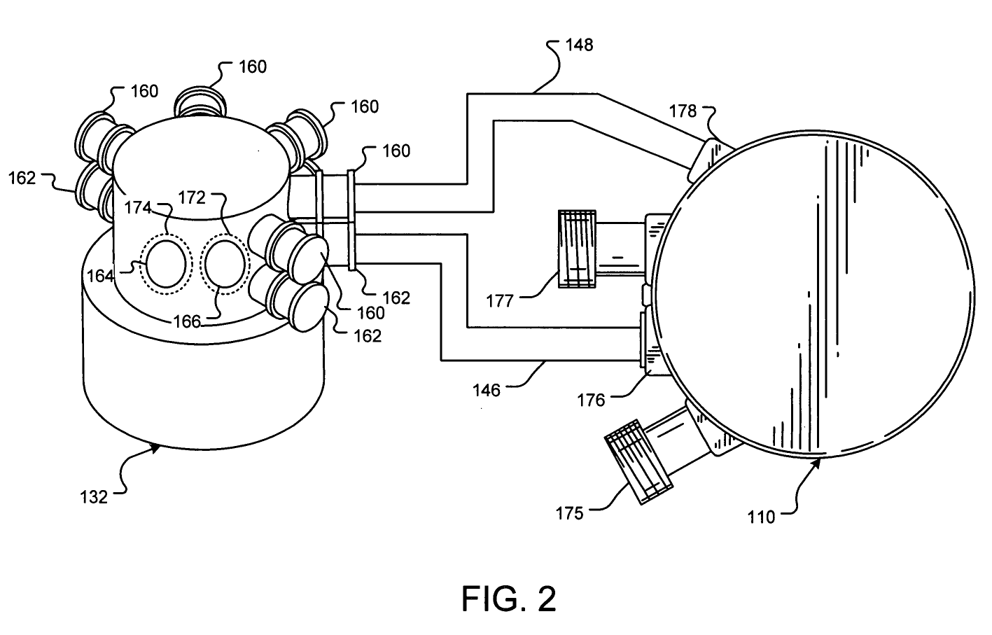

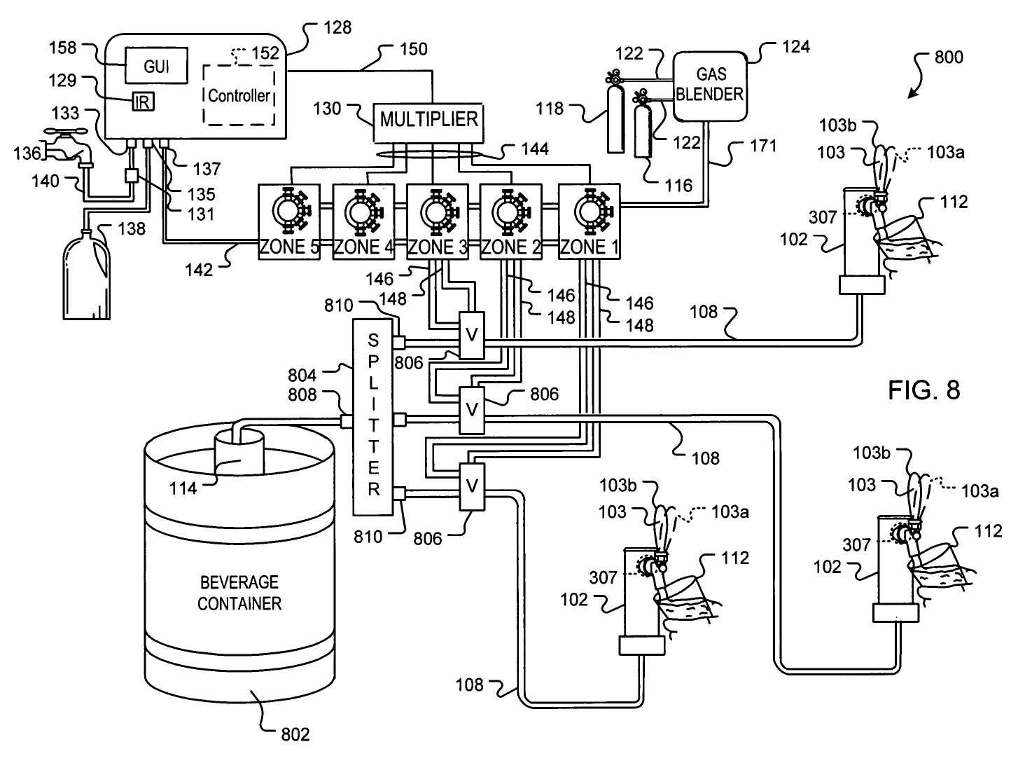

Alternatively, users may interact with the controller 152 by way of an external computer source, such as a handheld device, which may be wireless or wire-based. To effectuate the use wireless handheld devices, the control system 128 includes an infrared port 129 for communicating data to and from these devices. In yet another embodiment, the dispensing control system also includes a switching mechanism (not shown) for use in activating cleaning processes in desired zones, as described in greater detail with reference to FIGS. 2 and 8 of U.S. patent application Ser. Nos. 10/985,302 and 11/142,995, which, again, are incorporated by reference above.

The zone controller 130, which is also referred to as a “multiplier,” is a stand-alone component of the in-line cleaning system that works in combination with the GUI 158 or other data input means (e.g., external computer or switching mechanism) to activate the cleaning process in certain zones. As such, the zone controller 130 accepts user input from a source requesting the administration of one or more phases of the cleaning process to a zone and activates the phase(s) in that zone. The zone controller 130 is either an integrated circuit (IC) operable to receive and transmit signals for purposes of selecting the gas-fluid junctions 132 for activation, as described below, or a controller (e.g., PLC) programmed to receive and transmit data for these same purposes. In an alternative embodiment, the zone controller 130 may be a module integrated with the controller 152, and thus, contained within the housing of the control system 128.

The control system 128 is powered by a power source (not shown), which may be any conventional power source known to those skilled in the art. The control system 128 includes a first fluid input port 133 and a second fluid input port 135 through which water and chemical solutions, respectively, are input to the system 128. Water provided to the first fluid input port 133 is supplied by a potable water source 134 via a water input line 136. In an embodiment, a backflow prevention device 131 is positioned in the water input line 136 in order to preclude chemical solutions and contaminated water used during cleaning processes from backflowing into the potable water source 134.

Chemical solutions provided to the second fluid input port 134 are supplied from a solution container, such as a jug 138, via a solution input line 140. The control system 128 also includes a fluid output port 137 through which the water and chemical solutions are dispensed out of the system 128 by way of a fluid manifold 142. Those skilled in the art will appreciate that the control system 128 includes pumps, regulators or the like for enabling the flow of water and chemical solution into the system 128 via the water input line 136 and the solution input line 140 and subsequently out of the system 128 via the fluid manifold 142.

Water and one or more chemical solutions are provided by the control system 128 to the gas-fluid junctions 132 by way of the fluid manifold 142. The gas-fluid junctions 132, when activated by the zone controller as described below, distribute water and chemical solutions from the fluid manifold 142 to couplers 110 for distribution through the beverage lines 108, the dispense units 102 and any other component through which beverages flow. For illustration purposes, the gas-fluid junction 132 of zone 1 is shown as being connected to the beverage containers 104 by fluid lines 146 that carry the water and chemical solutions from this gas-fluid junction 132 to the couplers 110 when the gas-fluid junction 132 is activated.

The in-line cleaning system also includes gas lines 148 that carry a “control” gas from the gas-fluid junctions 132 to the associated couplers 110. Supply of the control gas to a coupler 110 dictates whether the beverage port 114 on the associated beverage container 104 is “open” or “closed,” and thus whether pressure from the gas blender 124 is allowed to enter the container 104. Consequently, the control gas dictates whether that beverage is operable to flow from the associated container 104 to the one or more corresponding dispense units 102 depending on the position (i.e., 103a or 103b) of the dispense unit(s) 103. To accomplish this, each of the couplers 110 includes a piston (not shown) that is responsive to the control gas to open the associated beverage port 114. The pressure from the gas blender 124 is constant and, as such, is substantially immediately introduced into the beverage container 104 in response to the piston opening the beverage port 114 under direction of the control gas. Conversely, terminating supply of gas between the output ports 160 and the gas input ports 178 causes the couplers 110 to bleed the gas in the attached containers 104 to atmospheric pressure thereby closing the associated beverage ports 114. By effectively providing such control, this gas is appropriately referred to throughout this description as “control gas.”

The operational state of the beverage dispensing system 100 involves the application of control gas to the couplers 110 and, during such application, beverages are operable to flow from the associated beverage containers 104 to the associated beverage lines 108 (depending, of course, on the positioning of the handles 103). Before any chemicals or water are supplied to a zone in the beverage dispensing system 100 for cleaning, supply of control gas to the couplers 110 in that zone is terminated and maintained terminated for the duration of the cleaning process. In effect, the non-application of control gas to and bleeding by these couplers 110 is intended to disable the flow of beverage from the associated beverage containers 104 to the associated beverage lines 108, at which time, the cleaning process may commence.

With reference now to FIG. 2, the gas-fluid junctions 132 and the couplers 110 are described in further detail. Each of the couplers 110 includes a beverage output port 177 from which beverages are supplied to an associated beverage line 108 during the beverage dispensing process. The beverage output ports 177 are fluidly coupled to the beverage lines 108 such that pressure supplied by the gas blender 124 is operable to force beverages from the beverage containers 104 to the beverage lines 108 with minimal loss.

Each of the gas-fluid junctions 132 include a fluid input port 164 and a gas input port 166. The fluid input port 164 is fluidly coupled to the fluid manifold 142 and thus accepts fluids (e.g., water and chemical solution) therefrom. In an embodiment, the gas input port 166 is coupled to the gas blender 124 by way of a control gas line 171, which is provided to each of the gas-fluid junctions 132 as generally depicted in FIG. 1. Alternatively, the gas input port 166 may be coupled directly to either gas tank 116 or 118 without going through the gas blender 124. The gas-fluid junctions 132 also include a plurality of gas output ports 160 and a plurality of fluid output ports 162. Each of the plurality of gas output ports 160 are paired with one of the plurality of fluid output ports 162.

A control gas valve 172, generally represented using dashed lines, is situated internal to each gas-fluid junction 132 and provides functionality for the gas-fluid junctions 132 to accept and reject gas from the gas blender 124. In this regard, the control gas valve 172 fluidly connects the gas input port 166 to the plurality of gas output ports 160 such that gas from the blender 124 is operable to flow therebetween. Each of the gas output ports 160 is coupled to a gas input port 178 on a coupler 110 via a gas line 148 such that gas may flow therebetween. The communication of gas between the output ports 160 on a gas-fluid junction 132 and the gas input ports 178 on the couplers 110 served by that gas-fluid junction 132 operates to maintain the “open” state of the beverage ports 114 on the associated beverage containers 104, as described above. Conversely, terminating supply of gas between the output ports 160 and the gas input ports 178 operates to bleed the gas in the attached containers 104 to atmospheric pressure and close the beverage ports 114 thereon, also as described above. By effectively providing such control, this gas is appropriately referred to throughout this description as “control gas.”

A fluid control valve 174, also generally represented using dashed lines, is situated internal to each gas-fluid junction 132 and provides functionality for the gas-fluid junctions 132 to accept and reject water and chemical solutions from the control system 128. Thus, with similar reference to the control gas valve 172, the fluid control valve 174 fluidly connects the fluid input port 164 to the plurality of fluid output ports 162 such that water and chemical solutions are operable to flow therebetween. Each fluid output port 162 is coupled to a fluid input port 176 on a coupler 110 via a fluid line 146 such that the water and chemical solutions may flow therebetween.

The control gas valve 172 and the fluid control valve 174 are controlled by the zone controller 130 via a low voltage line 144 input to the gas-fluid junction 132 from the zone controller 130. In normal state, i.e., when the beverage dispensing system 100 is in beverage dispensing mode, the zone controller 130 does not issue a current to any of the gas-fluid junctions 132. In response to direction from the control system 128 to apply the cleaning process to a specific zone, the zone controller 130 issues a current to the gas-fluid junction 132 served by the specified zone thereby “activating” that gas-fluid junction 132. Such activation causes the control gas valve 172 of that gas-fluid junction 132 to close, thereby rejecting gas from the gas blender 124. Consequently, the supply of control gas to the couplers 110 served by the activated gas-fluid junction 132 (i.e., the couplers 110 within the associated zone) is terminated thereby causing the pistons internal to the couplers 110 to disengage the beverage ports 114 on the associated beverage containers 104. Substantially concurrently, the issued current opens the fluid control valve 174 to enable the communication of water and chemical solutions to the associated couplers 110. However, these fluids are not provided to the activated gas-fluid junction 132 unless and until the controller 128 initiates a cleaning process within that zone.

In an embodiment, each of the couplers 110 include a pressure input port 175 through which the gas pressure supplied from the gas blender 124 is introduced to the couplers 110. As noted above, gas is provided to the pressure input ports 175 in constant fashion and used to force beverages from the beverage containers 104 to the beverage lines 108 when the pistons internal to the couplers 110 are engaged (i.e., when the control gas is “on”). In an alternative embodiment, application of the control gas by itself may provide a sufficient amount of pressure to force beverages from the containers 104 to the beverage lines 108 without the added need for pressure from the gas blender 124. In accordance with this embodiment, the gas line 171 directly connects between the gas blender 124 and the pressure input port 175 as well as the secondary regulators 126 and the connections between these regulators 126 and the couplers 110 are not necessary. The implementation is a manner of choice and, regardless of how such control is administered, termination of the control gas to a specific zone results in the same functionality, i.e., sealing the associated beverage ports 114, such that the couplers 110 in that zone exit the beverage dispensing mode and enter the cleaning mode (thus awaiting possible initiation of a cleaning process).

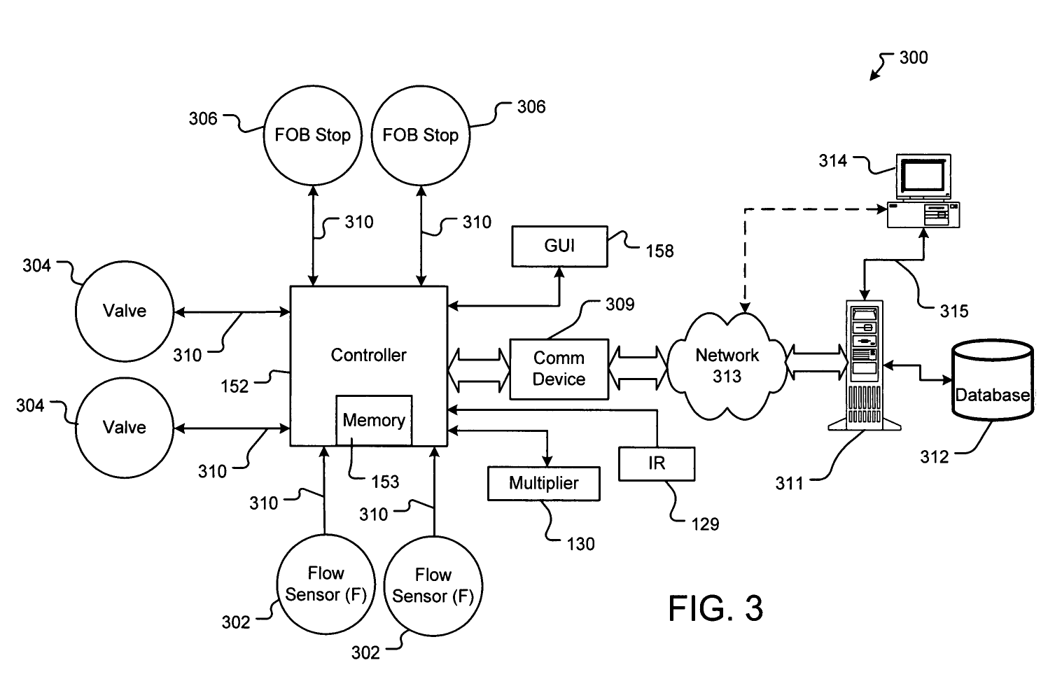

With the general environment in which embodiments of the present invention are applicable provided above, FIG. 3 depicts, in block diagram form, a system for monitoring and controlling (hereinafter, collectively referred to as “managing”) operation of the beverage dispensing system 100 of FIG. 1 in accordance with various embodiments of the present invention. The system 300 includes a plurality of sensors (e.g., flow sensors 302) and a plurality of electronically controllable components (e.g., valves 304 and fob stops 306), each of which are communicatively connected to the controller 152 by way of data communication connections 310. In an embodiment, the data communication connections 310 are wire-based communication media operable to carry a current indicative of sensed information from the sensors 302 and 304 to the controller 152 as well as a current indicative of instructions from the controller 152 to the controllable valves 306 and 308. These data communication connections 310 may additionally or alternatively embody wireless communication technology. It should be appreciated that the manner of implementation of the data communication connections 310 is a matter of choice and the present invention is not limited to one or the other, but rather, either wireless or wire-based technology may be employed alone or in combination with the other.

The controller 152 receives information sensed by the flow sensors 302 and the pressure sensors 304 (and any other sensors) and stores this information to memory 153. The memory 153 is shown as internal to the controller 152 and embodies any form of solid state, non-volatile memory known to those skilled in the art such as, for example, Random Access Memory (RAM), Read-Only Memory (ROM), Erasable Programmable ROM (EPROM), Electrically-Erasable Programmable ROM (EEPROM), Flash Memory and Programmable ROM, etc. Alternatively, the memory 153 may take the form of storage medium readable by an external peripheral device such as, for example, a hard disk, a CD-ROM, a DVD, a storage tape, etc.

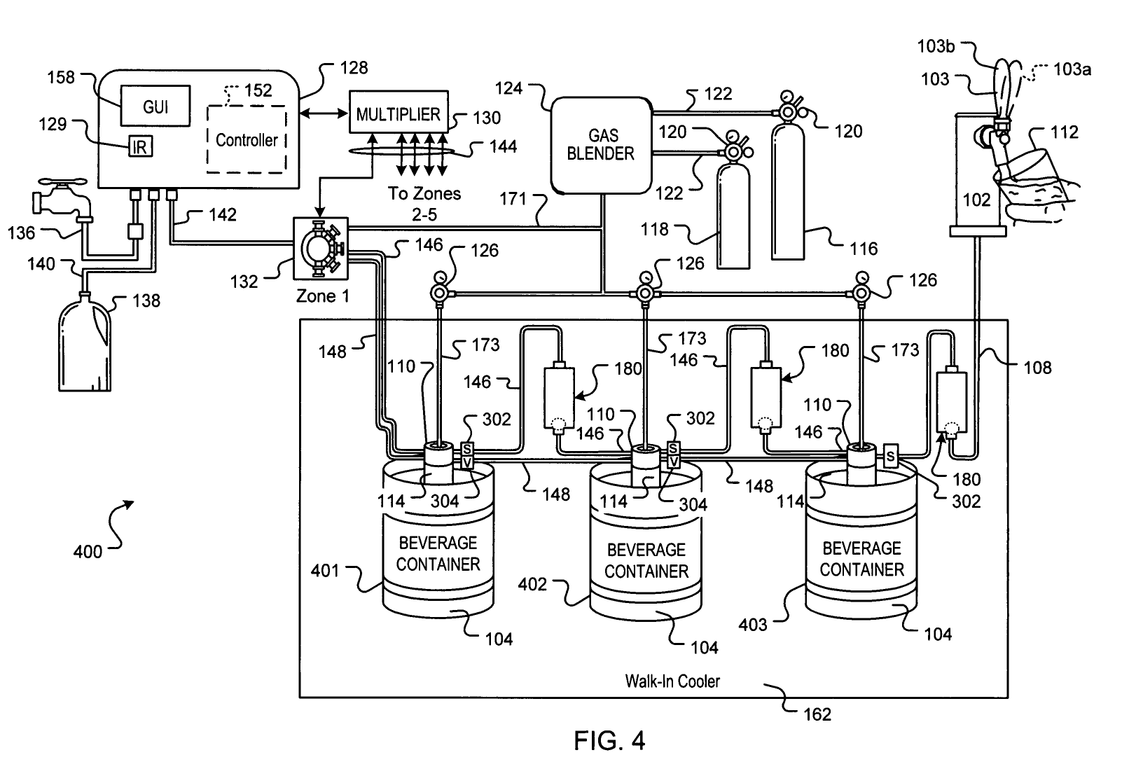

Regardless of the memory implementation, the controller 152 is operable to access the data stored on the memory 153 and analyze the data to monitor operation of the beverage dispensing system 100 by rendering conclusions regarding operation of the system 100. Furthermore, the controller 152 is operable to utilize this data along with other forms of generated or collected information to provide control over operation of the system 100. Exemplary analyses are described in greater detail in connection with FIGS. 4-9 in accordance with embodiments of the present invention.

The monitoring system 300 is shown to include parts of the dispensing control system 128 in addition to the controller 152 in accordance with an embodiment of the present invention. Specifically, the monitoring system 300 also includes the zone controller 130 (again, optional), the GUI 158 and the IR port 129. The GUI 158 and the IR port 129 provide users with access to data captured by the sensors 302 as well as any analyses performed by the controller 158 thereon. As such, user interaction is provided by touch screen interface (on GUI 158) or by way of a mobile computer such as a laptop, PDA or other handheld computing device (via IR port 129). Using the GUI 158 and/or a mobile computer interacting through the IR port (129), a user is provided with functionality for monitoring operation of the beverage dispensing system 100 as well as to view reports prepared using the sensed information.

In addition to the local user interaction provided by the GUI 158 and the IR port 129, the monitoring system 300 also provides users with the capability to monitor operation of the beverage dispensing system 100 from remote locations. To accomplish this, the monitoring system 300 includes a remote, or “server,” computer 310 communicatively connected to the controller 152 by way of a communications network 313. The server computer 311 communicates with the controller 152 to retrieve data stored on the memory 153, which may include any information sensed from the flow sensors 302 and any other sensors and/or information embodying analyses (e.g., reports) of such data performed by the controller 152 including, for example, data related to control over both the beverage dispensing process and the cleaning process. Once retrieved, the information is stored on a database 312 for future access by users. In this regard, the server computer 311 functions as a user interaction mechanism much like the GUI 158 and the IR port 129, but from a remote location relative to the actual location of the system 100.

The controller 152 connects to the communications network 313 by way of a communication device 309. The communication device 309 may be a modem, a network interface card (NIC) alone or in combination with a router, hub or Ethernet port, a wireless transmitter, etc. In an embodiment of the present invention, the communication device 309 periodically accesses the server computer 311 to provide data, e.g., raw sensed data (e.g., temperature readings, pressure readings, gas level readings and/or flow readings) or reports characterizing monitoring operations, for storage in the database 312. As such, the communication device 309 may access real-time data received by the controller 152 and any historical data stored on the local memory 153 for transfer to the database 312. In an alternative embodiment, the communication device 309 maintains communications with the server computer 311 over the communications network 313 continually; therefore, the local memory 153 is unnecessary for storing sensed data. Instead, the communication device 309 continually transmits real-time sensed data to the server computer 311.

In addition to data retrieval services, the server computer 311 is also operable to perform analyses on information retrieved from the controller 152 and prepare reports characterizing these analyses in similar fashion to the functionality described for the controller 152 above. That is, the server computer 311 retrieves raw sensed data (e.g., flow readings) stored on the memory 153 and analyzes the retrieved information to render conclusions regarding operation of the beverage dispensing system 100 with respect to at least flow characteristics. These conclusions are preferably placed into report format and stored on the database 312 for future access by users.

The controller 152 can also receive commands from the server computer 311 via the communications network 313 to provide a feedback loop to the control system 128. These commands may be used to control processes and operations of the beverage dispensing system 100. Such commands may include calibration commands, test commands, alarm commands, interactive communications between the system (100) operator or service technician and the server computer (311), and other remote control commands. This capability facilitates the management of multiple, geographically dispersed beverage dispense systems 100 by allowing an operator or the service technician to distribute control commands from a central location via the communications network 313.

A client computer 314, e.g., a thick or thin client, is connected to the server computer 311 by way of communication link 315 or, alternatively, the communications network 313, as shown in dashed lines. The client computer 314 communicates with the server computer 311 to retrieve data from the database 312 for presentation to a user. As such, the client computer 314 receives reports stored in the database 312 and provides these reports to a user. Alternatively, the client computer 314 may include an analysis application operable to receive raw sensed data (e.g., flow readings) stored in the database 312 and analyze this data to generate reports, as described above with reference to the controller 152 and the server computer 311.

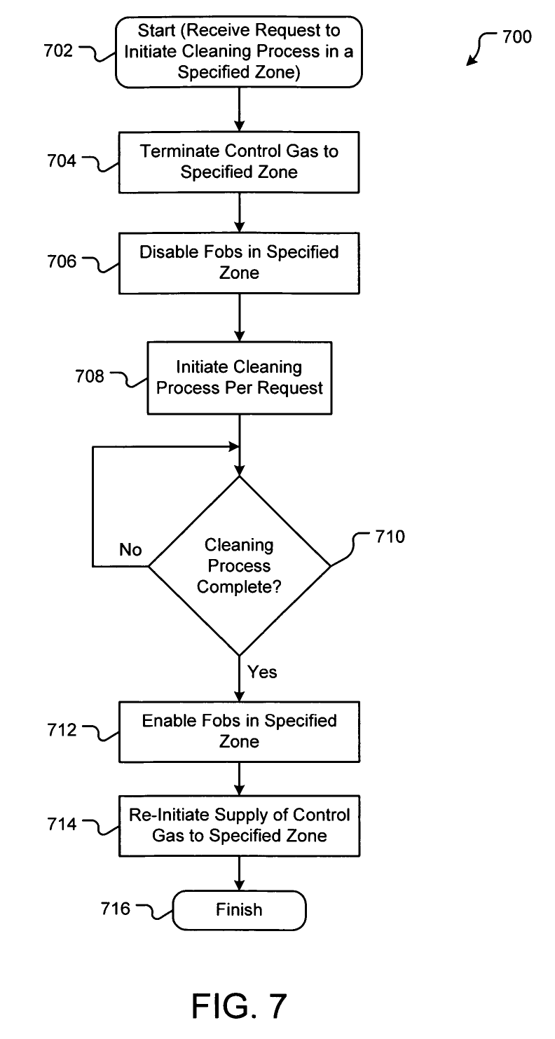

Referring now to FIG. 4, a beverage dispensing system 400 having a plurality of beverage containers 104 sharing a single beverage line 108 is shown in accordance with an embodiment of the present invention. For illustration purposes, these beverage containers 104 are referred to herein as “series-connected containers.” To accommodate for such a configuration, the beverage dispensing system 400 includes a plurality of flow sensors 302 and control gas valves 304, as shown in accordance with an exemplary layout in FIG. 4. The flow sensors 302 and the control gas valves 304 are monitored and controlled (respectively) by the controller 152 to provide functionality for changing between the series-connected containers 104, as described in detail below in conjunction with FIG. 7. Using this configuration, beverages are operable to flow to the associated dispense unit 102 until all of the series-connected containers 104 have emptied.

Referring further to the beverage dispensing system 400, three series-connected containers 104 are shown in accordance with an exemplary embodiment of the present invention, though, any number of containers 104 may be so connected. To illustrate embodiments of the present invention, each of the series-connected containers 104 within the beverage dispensing system 400 of FIG. 4 is identified in FIG. 4 using a separate reference numeral 401, 402 or 403. The beverage output port 177 on the coupler 110 attached to the last beverage container 403 in the series is fluidly coupled to the dispense unit 102 by way of the beverage line 108, exactly as described above in conjunction with FIG. 1. In contrast, each of the beverage output ports 177 on the couplers 110 on all other beverage containers (i.e., 401 and 402) within the series is fluidly coupled to the fluid input port 175 on the coupler 110 attached to the adjacent beverage container 104 in the series by way of a fluid line 146. Therefore, the beverage output port 177 on the coupler 110 attached to the first beverage container 401 in the series is fluidly coupled to the fluid input port 175 on the coupler 110 attached to the second beverage container 402 in the series. Similarly, the beverage output port 177 on the coupler 110 attached to the second beverage container 402 in the series is fluidly coupled to the fluid input port 175 on the coupler 110 attached to the third and last beverage container 403 in the series by way of a fluid line 146.

For reasons stated in connection with describing FIG. 1, the beverage line 108 and the fluid lines 146 between each of the series-connected beverage containers 104 include a fob 180 that functions as described above. With that said, the fobs 180 between the series-connected beverage containers 104 shut off flow within the associated fluid lines 146 in response to detecting foam therein. Consequently, as the first container 401 and the second container 402 run out of beverage, the associated fobs 180 shut down the output fluid lines 146 such that foam from the depleted beverage containers 104 is substantially precluded from being introduced to the next container 104 in the series.

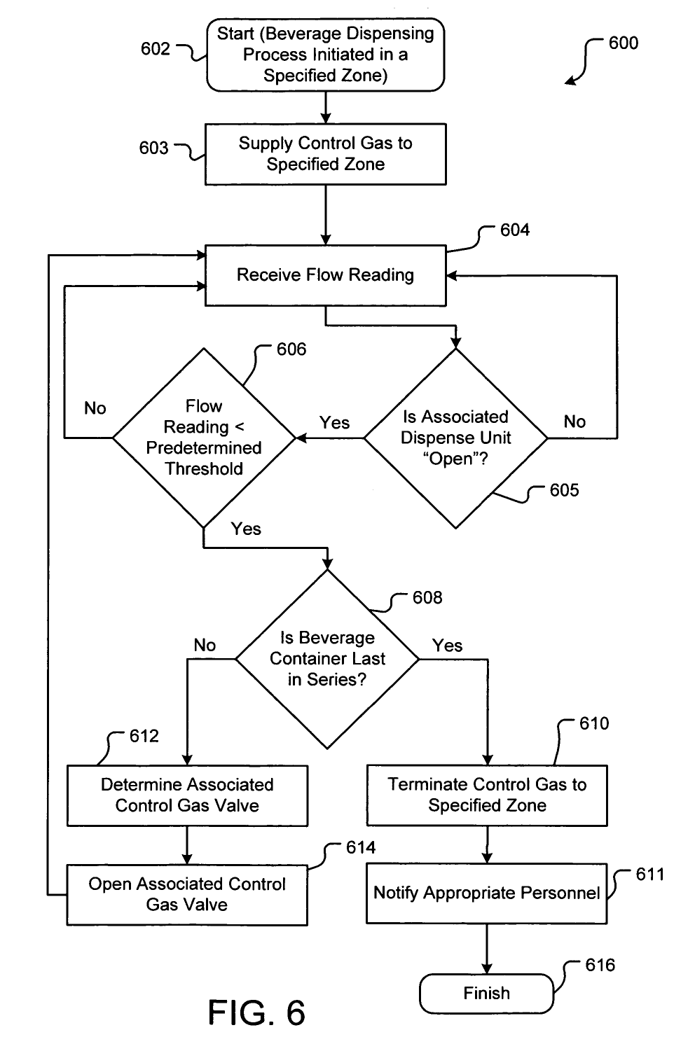

With the configuration of FIG. 4 in mind, FIG. 6 illustrates a process for controlling the beverage dispensing process of the beverage dispensing system 400 in accordance with an embodiment of the present invention. The control process 600 embodies a sequence of computer-implemented operations performed by the controller 152, the server computer 311 and/or the client computer 314, or a combination of any of these three computing modules, in accordance with embodiments of the present invention. For illustrative purposes, however, the control process 800 is described herein as performed by the controller 152.

The control process 600 is performed using an operation flow that begins with a start operation 602 and concludes with a finish operation 616. The operation flow of the control process 600 is initiated in response to initiation of a beverage dispensing process in a particular zone within the beverage dispensing system 400, at which time the start operation 602 passes the operation flow to an initiate operation 603. The initiate operation 603 initiates the beverage dispensing process in the specified zone by supplying the control gas to each of the gas lines 148 coupled to the gas-fluid junction 132 corresponding to the specified zone, as described above in conjunction with FIGS. 1 and 2.

With respect to the series connected beverage containers (e.g., 401, 402 or 403), the control gas valves 304 are initially set in the “off” position such that the control gas is initially only supplied to the coupler 110 on the first beverage container 401 in the series. As such, the beverage ports 114 on the second beverage container 402 and the third beverage container 403 are initially in the closed position such that beverages cannot be supplied to the dispense unit 102 therefrom, but rather only from the first beverage container 401. After the control gas has been enabled within the specified zone, the operation flow passes to a receive operation 604.

The receive operation 604 receives flow readings from flow sensors 302 in the beverage dispensing system 400. The flow readings indicate measured volumetric rates of flow at which beverages are being supplied from beverage containers (e.g., 401, 402 and 403) in the series to the associated dispense unit 102 via either a fluid line 146 or a beverage line 108. During the first pass through the control process 600, the receive operation 604 receives flow readings generated by the flow sensor 602 fluidly coupled to the beverage output port 177 on the coupler 110 attached to the first beverage container 402 in the series. During subsequent iterations of this process 600, however, these flow readings will be received in sequence from the second beverage container 402 and then the third beverage container 403 as dictated by the third query operation 608, which is described in more detail below. The controller 152 therefore maintains knowledge identifying the sensor 302 from which a flow reading is received. In an embodiment, such knowledge is determined based on which iteration the control process 600 is currently in. Alternatively, such information may be determined based on identification information transmitted with the measured flow information. In this embodiment, such identification information uniquely identifies the transmitting sensor 302 from the other sensors 302 within the beverage dispensing system 400. Regardless of the implementation, the receive operation 604 passes the operation flow to a first query operation 605 in response to receipt of a flow reading.

The first query operation 605 determines whether the flow reading is associated with a fluid line 146 or beverage line 108 corresponding to a dispense unit 102 that is currently open such that beverage is operable for dispensing to a point of use. In an embodiment, such a determination is made by the controller 152 receiving sensed information indicating whether the handle 103 is in the on position 103b (dispense unit 102=open) or the off position 103a (dispense unit 102=closed). If the dispense unit 102 is currently closed, the volumetric rate of flow indicated in the measured reading is substantially zero units (e.g., zero liters/second) and thus, not indicative of whether the associated container (e.g., 401, 402 or 403) is almost empty of beverage. In this case, the first query operation 605 passes the operation flow back to the receive operation 604 until a next flow reading is received. If, however, the first query 605 determines that the associated dispense unit is open, then the operation flow is passed to a second query operation 606.

The second query operation 606 analyzes the received flow reading to determine whether the measured volumetric rate of flow is less than a predetermined threshold value thereby indicating whether the associated beverage container (e.g., 401, 402 or 403) is almost or substantially empty of beverage. In an embodiment in which the beverage containers 104 embody beer kegs, the predetermined threshold value is a volumetric rate of flow associated with the foamy substance that causes the internal float 185 in the fob 180 to seal the beverage output port 184. If the measured volumetric rate of flow is determined to be less than the predetermined threshold value, the operation flow passes to a third query operation 608. Otherwise, the second query operation 606 passes the operation flow back to the receive operation 604 until a next flow reading is received. It should be appreciated that the receive operation 604 may receive any number of flow readings from a single sensor 302 at any specified interval prior to detecting a measured reading less than the predetermined threshold value.

Following the “yes” branch of the second query operation 606, the control process 600 has detected that one of the beverage containers (e.g., 401, 402 or 403) in the series is almost or substantially empty and thus, should be disabled for the time being. The third query operation 608 determines whether this emptying beverage container (e.g., 401, 402 or 403) is the last beverage container 104 in the series (i.e., in FIG. 4, beverage container 403). That is, the third query operation 608 makes a determination as to whether the emptying beverage container (e.g., 401, 402 or 403) is directly coupled to the beverage line 108 and, thus, the “closest” beverage container 104 to the dispense unit 102. Such a determination is made based on either the current iteration of the control process 600 or by way of identification information transmitted with the measured reading, as described above. If the emptying beverage container (e.g., 401, 402 or 403) is the last beverage container 104 in the series, the operation flow passes to a terminate operation 610, which terminates supply of the control gas to the specified zone thereby concluding the beverage dispensing process therein to allow for beverage replenishment.

From the terminate operation 610, the operation flow passes to an optional notification operation 611, which issues a notification to appropriate personnel or an authorized user of the beverage dispensing system 400 that the beverage requires replenishment. Such a notification may be presented to the user through the GUI 158 or by way of a network communication such as, for example, email, facsimile or telephone. From the notification operation 611 (if administered) or the terminate operation (if the notification operation 611 is not administered), the operation flow concludes at the finish operation 616.

If, however, the third query operation 608 determines that the emptying beverage container (e.g., 401, 402 or 403) is not the last beverage container 104 in the series, the operation flow is passes to a determine operation 612. The determine operation 612 determines the control gas valve 304 associated with the sensor 302 from which the flow reading originated. Once this control gas valve 304 is determined, the operation flow passes to an open valve operation 614. The open valve operation 614 opens the associated control gas valve 304 such that control gas is provided to the coupler 110 attached to the beverage container (e.g., 401, 402 or 403) next in the series. Consequently, this next beverage container (e.g., 401, 402 or 403) is operable to supply beverage to the associated dispense unit 102. From the open valve operation 614, the operation flow passes back to the receive operation 604 and proceeds as described above.

While FIG. 6 describes control over the beverage dispensing system 400 of FIG. 4 relative to performance of a beverage dispensing process, the incorporation of flow sensors 302 and control gas valves 304 in the series-connected container 104 also facilitates application of the cleaning process. To further assist with the cleaning process, an embodiment of the present invention involves providing a mechanism for automating control over the positioning of the internal float 185 within the chamber 186 to therefore preclude sealing of the beverage output port 184 by the internal float 185, as described in conjunction with FIG. 7.

With that said, FIG. 5 depicts a fob stop 306 that is controllable by the controller 152 (via data communication lines 310) to excite a magnetic field within the chamber 186. In this embodiment, the internal float 185 has metallic properties (i.e., made of metal or containing metal) and, as the magnetic field is concentrated on a wall of the chamber 186, the internal float 185 is drawn away from the beverage output port 184 and to the wall of the chamber 186. The beverage output port 184 is therefore unsealed such that fluids may flow through the fob 180, thereby “opening” the associated fluid line 146 for fluid communication.

Referring now to FIG. 7, a process 700 for controlling operation of the beverage dispensing system 400 to administer a cleaning process thereto is shown in accordance with an embodiment of the present invention. Like the control process 600 (FIG. 6), the control process 700 embodies a sequence of computer-implemented operations performed by the controller 152, the server computer 311 and/or the client computer 314, or a combination of any of these three computing modules, in accordance with embodiments of the present invention. For illustrative purposes, therefore, the control process 700 is also described herein as performed by the controller 152.

The control process 700 is performed using an operation flow that begins with a start operation 702 and concludes with a terminate operation 716. The start operation 702 is initiated in response to receipt by the controller 152 of a request to initiate a cleaning process relative to any one zone in the beverage dispensing system 500. Such a request may embody instructions received through the GUI 158, the IR Port 129, the communication device 309 (e.g., by way of server computer 311 or client computer 314) or by way of key switches, as described in greater detail in incorporated U.S. patent application Ser. Nos. 10/985,302 and 11/142,995. After this request has been received, the operation flow passes from the start operation 702 to a terminate operation 704.

The terminate operation 704 terminates supply of the control gas to the specified zone thereby concluding the beverage dispensing process in preparation for starting the cleaning process in that zone. In an embodiment, the terminate operation 704 suspends operation of the control process 600 of FIG. 6 regardless of the current position of the operation flow. The control process 600 is then resumed at this position in response to the control gas being re-supplied to the specified zone by an enable operation 714, which is further described below. Alternatively, the terminate operation may conclude altogether the control process 600 of FIG. 6 such that in response to the enable operation 714, the operation flow of this process 600 is re-initiated at the start operation 602. The implementation is a matter of choice, and regardless of the choice, the operation flow of the control process 700 is passed to a disable fob operation 704 upon completion of the terminate operation 704.

The disable fob operation 704 disables the fobs 180 within the specified zone by precluding the internal float 185 from sealing off the beverage output port 184. As shown in FIG. 5 and described above, an embodiment of the present invention involves the controller 152 issuing a command to each of the fob stops 306 within the specified zone thereby generating a magnetic field that is concentrated on a wall of the chamber 186. Consequently, the internal float 185, which as noted above, has metallic properties, is caused to move toward the applicable wall and away from the beverage output port 184. As an example, such a command may be in the form of a current and the fob stop may be a solenoid valve that, in response to application of the current from the controller 152, generates the desired magnetic field. As solenoid valves are just one type of mechanism that could be used as fob stops 306, it should be appreciated that other equivalent magnetic field generating devices may be utilized. After all of the fobs 180 in the specified zone have been disabled, the operation flow of the control process 700 passes to a clean operation 708.

The clean operation 708 initiates application of the cleaning process to the specified zone per the received request and subsequently passes the operation flow to a query operation 710. The query operation 710 determines whether the cleaning process is complete and, if so, passes the operation flow to an enable operation 712. Otherwise, the query operation 710 passes the operation flow in a loop during which the query operation 710 is repetitively performed until the cleaning process is complete. After such completion, the enable operation 712 enables the fobs 180 in the specified zone such that the fobs 180 are operable to perform intended functionality (i.e., detecting foam and disabling flow in beverage path, e.g., fluid lines 146 or beverage lines 108). From the enable operation 712, the operation flow passes to a supply operation 714.

The supply operation 714 re-initiates supply of the control as to each of the gas lines 148 coupled to the gas-fluid junction 132 corresponding to the specified zone, thereby preparing the beverage dispensing system 800 for the beverage dispensing process. After the control gas has been re-supplied to the specified zone, the operation flow passes to the terminate operation 716.

While FIGS. 3-7 are directed to embodiments of the present invention that involve increasing beverage capacity using series-connected beverages, e.g., 401, 402 and 403, FIG. 8 illustrates a system 800 having increased beverage capacity using an enlarged beverage container 802 referred to as a “tank valve.” As known to those skilled in the art, a tank valve is operable to store a considerable amount of beverage more than conventional kegs. With that said, however, the coupler 110 does not fit on tank valves 802 as it would on conventional kegs. An embodiment of the present invention therefore involves configuring the beverage dispensing system 100 to accommodate for a tank valve 802 or any other beverage container on which the coupler 110 is not operable to attach, thereby resulting in the beverage dispensing system 800 shown in FIG. 8.

More specifically, the beverage dispensing system 800 includes a splitter 804 and a plurality of gas powered valves 806. The splitter 806 includes an input 808 and a plurality of outputs 810. Each of the plurality of outputs 810 is fluidly coupled to a dispense unit 102 by way of a beverage line 108. Further, one of the plurality of gas-powered valves 806 is positioned within each of the beverage lines 108 preferably in close proximity to the beverage line splitter 804. Like the couplers 110, the gas powered valves 806 are communicatively coupled to the gas-fluid junctions 132 by way of fluid lines 146 and gas lines 148.

In general, the valves 806 function in similar fashion to the couplers 110 described above. During the beverage dispensing process, control gas is provided between one or more gas-fluid junctions 132 and the valves 806 within the zone administered by that gas-fluid junction 132 and beverages are operable to flow between the splitter 804 and the associated dispense units 102. Activation of a gas-fluid junction 132 (e.g., by multiplier 130 or controller 152 if multiplier 130 is not utilized) terminates the application of control gas to all of the gas-powered valves 806 within the zone administered by the activated gas-fluid junction 132. Consequently, the gas powered valves 806 in that zone disable flow between the beverage line splitter 804 and those valves 806 and enable flow between the fluid lines 146 and the beverage line 108. As such, the valves 806 in that zone are positioned in cleaning mode such that, if cleaning is desired, the cleaning process may be applied to that zone. The gas powered valves 806 therefore perform substantially similar functionality as the couplers 110 by disabling beverage communication between the splitter 804 and the beverage lines 108 in similar fashion to the couplers 110 disabling beverage communication between the beverage ports 114 and the beverage lines 108.

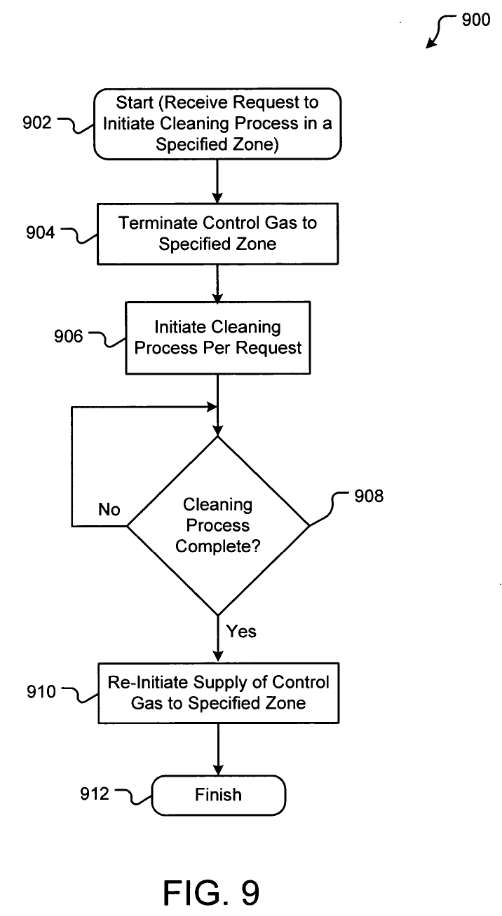

Referring now to FIG. 9, a process 900 for controlling operation of the beverage dispensing system 800 to administer a cleaning process thereto is shown in accordance with an embodiment of the present invention. Like the control processes 600 (FIG. 6) and 700 (FIG. 7), the control process 900 embodies a sequence of computer-implemented operations performed by the controller 152, the server computer 311 and/or the client computer 314, or a combination of any of these three computing modules, in accordance with embodiments of the present invention. For illustrative purposes, therefore, the control process 900 is also described herein as performed by the controller 152.

The control process 900 is performed using an operation flow that begins with a start operation 902 and concludes with a terminate operation 912. The start operation 902 is initiated in response to receipt by the controller 152 of a request to initiate a cleaning process relative to any one zone in the beverage dispensing system 800. Such a request may embody instructions received through the GUI 158, the IR Port 129, the communication device 309 (e.g., by way of server computer 311 or client computer 314) or by way of key switches, as described in greater detail in incorporated U.S. patent application Ser. Nos. 10/985,302 and 11/142,995. After this request has been received, the operation flow passes from the start operation 902 to a terminate operation 904.

The terminate operation 904 terminates supply of the control gas to the specified zone thereby concluding the beverage dispensing process in preparation for starting the cleaning process in that zone. As described in conjunction with FIG. 8, the terminate operation 904 involves activating the associated gas-fluid junction 132 such that the flow of control gas is disabled between that junction 132 and any associated valves 806. From the terminate operation 904, the operation flow of the control process 900 is passed to a clean operation 906.

The clean operation 906 initiates application of the cleaning process to the specified zone per the received request and subsequently passes the operation flow to a query operation 908. The query operation 908 determines whether the cleaning process is complete and, if so, passes the operation flow to a supply operation 910. Otherwise, the query operation 908 passes the operation flow in a loop during which the query operation 908 is repetitively performed until the cleaning process is complete. After such completion, the supply operation 910 re-initiates supply of the control gas to each of the gas lines 148 coupled to the gas-fluid junction 132 corresponding to the specified zone, thereby preparing the beverage dispensing system 800 for the beverage dispensing process. After the control gas has been re-supplied to the specified zone, the operation flow passes to the terminate operation 912.

Having described the embodiments of the present invention with reference to the figures above, it should be appreciated that numerous modifications may be made to the present invention that will readily suggest themselves to those skilled in the art and which are encompassed in the spirit of the invention disclosed and as defined in the appended claims. Indeed, while a presently preferred embodiment has been described for purposes of this disclosure, various changes and modifications may be made which are well within the scope of the present invention. For example, while described in accordance with an exemplary embodiment as applicable to beverage dispensing, as noted above, the embodiments described above are also applicable to other forms and purposes of fluid dispensing, such as, without limitation, for use in endoscope cleaning, paint dispensing and slush (e.g., ice fluid) dispensing.

Furthermore, control over the beverage dispensing system 400 having series connected beverage containers 401, 402, 403 is shown in FIG. 6 in accordance with an embodiment to be administered by a control process 600 that involves switching between the containers 401, 402, 403 in response to detecting that the beverage has been depleted therefrom using flow-based measurements. In an alternative embodiment, other forms of measurement may be used to indicate the volume of beverage remaining in the beverage containers 401, 402 and 403. For example, the flow sensors 302 may be replaced or supplemented with other types of sensors that measure either directly or indirectly the volume of the containers 401, 402 and 403. In accordance with these embodiments, the first query operation 605 may not be necessary and therefore removed from the control process such that the operation flow passes from the receive operation 604 directly to the second query operation 606. For example, if the flow sensors 302 are replaced by volumetric measuring devices that directly measure the volume of fluid in the containers 401, 402, 403, then such direct measurements remove the motivation for checking as to whether the dispense units 102 are “opened” and, therefore, the first query operation 605 may be redacted from the operation flow.

In addition, embodiments for controlling fobs are illustrated herein using a conventional type fob detector 180 having a chamber 186 and an internal float 185, as shown in FIGS. 1, 4 and 5 in accordance with an exemplary embodiment. However, the present invention as it relates to fob controlling is not limited to this specific type of fob that shown in the figures and described above, but rather, it should be appreciated that controller-based management over other types of fobs or means for shutting off beverage lines 108 (e.g., optical means, hall flow sensors, etc.) are well within the scope of the present invention. Similarly, it should be appreciated that technologies other than magnetic technologies may be used as the fob stop 306.

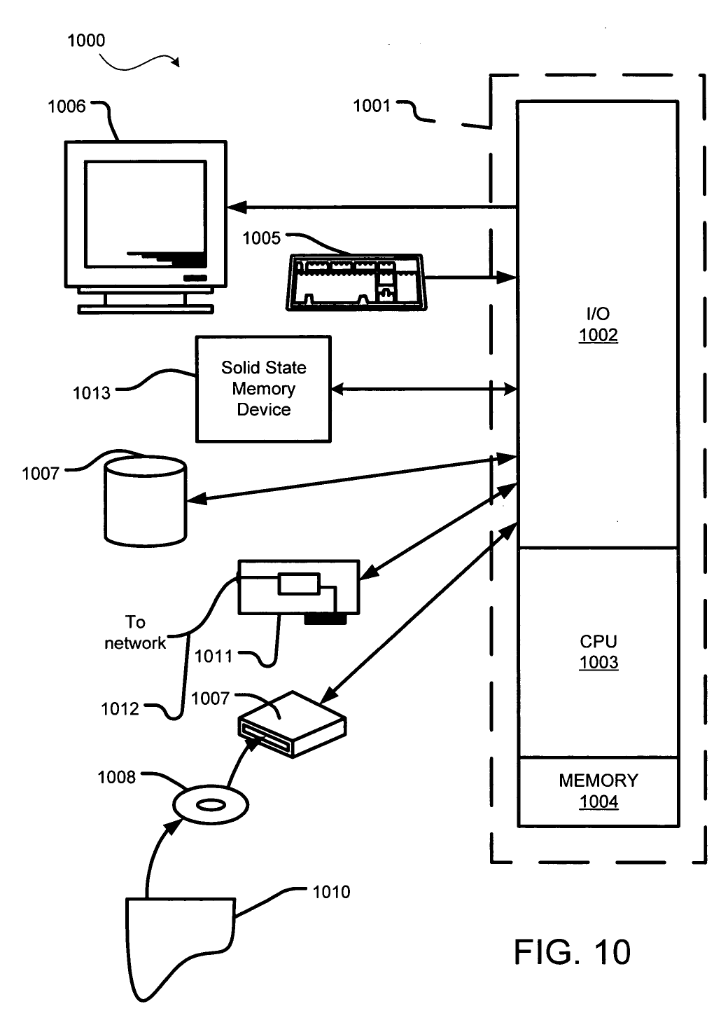

Even further, the controller 152 is described herein as conventional electrical and electronic devices/components, such as, without limitation, programmable logic controllers (PLC's) and logic components, but may alternatively be a processor 1001 integrated into a computer readable medium environment as optionally shown in FIG. 10. As such, the logical operations of the present invention described in FIGS. 6-7 and 9 may be administered by the processor 1001 in this computer readable medium environment.

Referring to FIG. 10, such an embodiment is shown by a computing system 1000 capable of executing a computer readable medium embodiment of the present invention. In such a system, data and program files may be input to the computing system 1000, which reads the files and executes the programs therein. Some of the elements of a computing system 1000 are shown in FIG. 10 wherein the processor 1001 includes an input/output (I/O) section 1002, a microprocessor, or Central Processing Unit (CPU) 1003, and a memory section 1004. The present invention is optionally implemented in this embodiment in software or firmware modules loaded in memory 1004 and/or stored on a solid state, non-volatile memory device 1013, a configured CD-ROM 1008 or a disk storage unit 1009. As such, the computing system 1000 is used as a “special-purpose” machine for implementing the present invention.

The I/O section 1002 is connected to a user input module 1005, e.g., a keyboard, a display unit 1006, etc., and one or more program storage devices, such as, without limitation, the solid state, non-volatile memory device 1013, the disk storage unit 1009, and the disk drive unit 1007. The solid state, non-volatile memory device 1013 is an embedded memory device for storing instructions and commands in a form readable by the CPU 1003. In accordance with various embodiments, the solid state, non-volatile memory device 1013 may be Read-Only Memory (ROM), an Erasable Programmable ROM (EPROM), Electrically-Erasable Programmable ROM (EEPROM), a Flash Memory or a Programmable ROM, or any other form of solid state, non-volatile memory. In accordance with this embodiment, the disk drive unit 1007 may be a CD-ROM driver unit capable of reading the CD-ROM medium 1008, which typically contains programs 1010 and data. Alternatively, the disk drive unit 1007 may be replaced or supplemented by a floppy drive unit, a tape drive unit, or other storage medium drive unit. Computer readable media containing mechanisms (e.g., instructions, modules) to effectuate the systems and methods in accordance with the present invention may reside in the memory section 1004, the solid state, non-volatile memory device 1013, the disk storage unit 1009 or the CD-ROM medium 1008. Further, the computer readable media may be embodied in electrical signals representing data bits causing a transformation or reduction of the electrical signal representation, and the maintenance of data bits at memory locations in the memory 1004, the solid state, non-volatile memory device 1013, the configured CD-ROM 1008 or the storage unit 1009 to thereby reconfigure or otherwise alter the operation of the computing system 1000, as well as other processing signals. The memory locations where data bits are maintained are physical locations that have particular electrical, magnetic, or optical properties corresponding to the data bits.

In accordance with a computer readable medium embodiment of the present invention, software instructions stored on the solid state, non-volatile memory device 1013, the disk storage unit 1009, or the CD-ROM 1008 are executed by the CPU 1003. In this embodiment, these instructions may be directed toward administering application of a cleaning process, customized or non-customized, to a beverage dispensing system. Data used in the analysis of such applications may be stored in memory section 1004, or on the solid state, non-volatile memory device 1013, the disk storage unit 1009, the disk drive unit 1007 or other storage medium units coupled to the system 1000.

In accordance with one embodiment, the computing system 1000 further comprises an operating system and usually one or more application programs. Such an embodiment is familiar to those of ordinary skill in the art. The operating system comprises a set of programs that control operations of the computing system 1000 and allocation of resources. The set of programs, inclusive of certain utility programs, also provide a graphical user interface to the user. An application program is software that runs on top of the operating system software and uses computer resources made available through the operating system to perform application specific tasks desired by the user. The operating system is operable to multitask, i.e., execute computing tasks in multiple threads, and thus may be any of the following: any of Microsoft Corporation's “WINDOWS” operating systems, IBM's OS/2 WARP, Apple's MACINTOSH OSX operating system, Linux, UNIX, etc.

In accordance with yet another embodiment, the processor 1001 connects to the communications network 313 by way of a network interface, such as the network adapter 1011 shown in FIG. 10. Through this network connection, the processor 1001 is operable to transmit information to the remote computer 310, as described in connection with the controller 152 shown in FIG. 3. Various types of information may be transmitted from the processor 1001 to the remote computer 310 over the network connection. In addition, the network adaptor 1011 enables users at the remote computer 310 or the client computer 314 the ability to issue commands to the processor 1001 if so desired, also as described above in connection with the controller 152 shown in FIGS. 1 and 4.

Additionally, while not shown in FIG. 4, the valves 304 on the fluid lines 148 prior to the last beverage container 403 may include manual override switches such that the series-connected containers (401, 402 and 403) maintain functionality in case of a power outage.

Furthermore, while only one series-connected sequence of containers (e.g., 401, 402 and 403) is shown in FIG. 4 and described in connection with FIG. 6 for illustrative purposes, it should also be appreciated that the control process 600 described therein may be practiced in multiple instances or process threads being performed substantially in parallel with each other. Such substantially parallel processing is performed until a beverage line 108 having all empty containers 104 is detected, at which time, the specified zone is shut down for replenishment of the associated beverage.

In addition, the beverage dispensing system 800 is shown in and described in connection with FIG. 8 to illustrate an embodiment of the present invention in which split beverage lines 108 are utilized. While fobs 180 are not described as being part of this system 800, it should be appreciated that embodiments of the present invention involve fitting each of the split beverage lines 108 with a fob 108 and an associated fob stop 306, as described with reference to FIG. 5. In such a case, the control process 900 includes operations for disabling the fobs 180 prior to cleaning and enabling the fobs 180 after cleaning, as described with reference to the disable operation 706 and the enable operation 712 in FIG. 7. Furthermore, while each of the split beverage lines 108 are shown in FIG. 8 as serving separate zones for illustration purposes, it should be appreciated that any number of the split beverage lines 108 may serve a single zone and, in this case, a single valve 806 may include an output for each of these split lines 108.

What is claimed is:

1. A method implemented at least in part by a computer for managing operation of a fluid dispensing system, wherein a fluid stored in a plurality of series-connected fluid containers is supplied in sequence therefrom and provided to a fluid line for use in carrying the fluid to a dispense unit, the method comprising:
receiving sensed information indicating an actual volume of the fluid contained in a first of the plurality of series-connected fluid containers;
analyzing the sensed information against a predetermined threshold parameter; and
disabling flow of the fluid from the first series-connected fluid container to the fluid line if the actual volume of the fluid contained in the first series-connected fluid container is less than the predetermined threshold parameter; and
in response to the disabling act, enabling flow of the fluid from a second of the plurality of series-connected fluid containers to the fluid line.

2. A method as defined in claim 1, further comprising:
receiving sensed information indicating an actual volume the fluid contained in the second series-connected fluid container;
analyzing the sensed information indicating the actual volume of fluid contained in the second series-connected container against the predetermined threshold parameter; and
disabling flow of the fluid from the second series-connected fluid container to the fluid line if the actual volume of the fluid contained in the second series-connected fluid container to the fluid line is less than the predetermined threshold parameter.

3. A method as defined in claim 2, further comprising:
in response to the disabling act, if a third fluid container is connected in series with the first and the second fluid container, enabling flow of the fluid from the third series-connected fluid container to the fluid line.

4. A method as defined in claim 2, further comprising:
in response to the disabling act, if a third fluid container is not connected in series with the first and the second fluid container, issuing notification to appropriate personnel that the fluid needs replenishing.

5. A method as defined in claim 1, wherein the fluid dispensing system comprises an integrated cleaning system, the method further comprising:
receiving a request to clean the fluid line; and
in response to the request, disabling flow of the fluid to the fluid line from both the first series-connected container and the second series-connected fluid container.

6. A method as defined in claim 5, wherein the disabling act comprises:
initiating a cleaning process by controlling fluid ports on both the first and the second series-connected fluid containers through which the fluid is supplied to the fluid line from the first and the second series-connected fluid container such that communication of the fluid from either fluid port to the fluid line is precluded.

7. A method as defined in claim 6, further comprising:
determining whether the cleaning process is complete;
in response to determining that the cleaning process is complete, controlling the fluid port on both the first series-connected fluid container such that communication of fluid to the fluid line is enabled and controlling the fluid port on the second series-connected fluid container such that communication of fluid to the fluid line is disabled; and
repeating the receiving, the analyzing, the disabling and the enabling acts.

8. A method as defined in claim 1, wherein the receiving act comprises:
receiving the sensed information from a flow sensor measuring a rate of flow from the first series-connected fluid container to the fluid line, wherein the predetermined threshold parameter embodies a flow rate that indicates a substantial depletion of fluid from the first series-connected fluid container.

9. A fluid dispensing system having a plurality of series-connected fluid containers from which a fluid is supplied in sequence to a dispense unit via an output fluid line, the system comprising:
a controller;
a first coupler attached to a first of the plurality of series-connected fluid containers and controllable by the controller to enable and disable flow of the fluid from the first series-connected fluid container to the output fluid line;
a second coupler attached to a second of the plurality of series-connected fluid containers and controllable by the controller to enable and disable flow of the fluid from the second series-connected fluid container to the output fluid line, wherein the second coupler is fluidly connected to the first coupler by an intermediate fluid line such that fluid supplied to the first container is communicated to the output fluid line by way of the intermediate fluid line and the second coupler;
a flow sensor operable to monitor flow of the fluid in the intermediate fluid line and transmit measured flow readings to the controller, wherein the controller, in response to determining that a measured flow reading fails to satisfy a predetermined threshold value, is operable to instruct the first coupler to disable flow of the fluid from the first series-connected fluid container to the intermediate fluid line and further operable to instruct the second coupler to enable flow of the fluid from the second series-connected fluid container to the output fluid line.

10. A fluid dispensing system as defined in claim 9, further comprising:
a fob detector positioned in relation to the intermediate fluid line and operable to seal off the intermediate fluid line in response to detecting substantial depletion of the fluid in the first series-connected fluid container; and
a device positioned adjacent the fob detector and controllable by the controller to disable the fob.

11. A fluid dispensing system as defined in claim 10, wherein the fob detector comprises:
a chamber;
an input port fluidly connected to the first coupler by way of a first portion of the intermediate fluid line, wherein the input port accepts the fluid from the first coupler via the first portion of the intermediate fluid line and provides the accepted fluid to the chamber;
an output port fluidly connected to the second coupler by way of a second portion of the intermediate fluid line, wherein the output port provides fluid contained in the chamber to the second coupler via the second portion of the intermediate fluid line; and
an internal float that seals the output port in response to the chamber being empty of the fluid.

12. A fluid dispensing system as defined in claim 11, wherein the internal float comprises metal and wherein the device comprises an electromagnet, the device being controlled by the controller to disable the fob by the controller issuing a current to the electromagnet thereby creating a magnetic field that causes movement by the internal float away from the output port.

13. A fluid dispensing system as defined in claim 9, wherein the fluid comprises a beverage.

14. A fluid dispensing system as defined in claim 9, further comprising:
a pressure source operable to provide a control gas for use by the controller in controlling functionality of the first coupler and the second coupler relative to supply of the fluid therefrom, wherein:
supply of the control gas to the first coupler enables flow of the fluid from the first series-connected fluid container to the intermediate fluid line and termination of the control gas to the first coupler disables flow of the fluid from the first series-connected fluid container to the intermediate fluid line; and
supply of the control gas to the second coupler enables flow of the fluid from the second series-connected fluid container to the output fluid line and termination of the control gas to the second coupler disables flow of the fluid from the second series-connected fluid container to the output fluid line.

15. A method implemented at least in part by a computer for managing operation of a fluid dispensing system having a fluid container from which a fluid is supplied to a plurality of dispense units via a plurality of fluid lines, wherein the fluid is output from the fluid container and provided to a splitter that supplies each of the plurality of fluid lines with the fluid, the method comprising:
positioning a first controllable valve in a first fluid line and a second controllable valve in a second fluid line;
enabling the first controllable valve and the second controllable valve such that fluid is allowed to flow from the splitter to the first and second fluid lines;
receiving an instruction that requests cleaning of the first fluid line but that does not request cleaning of the second fluid line;
in response to the instruction, disabling the first controllable valve such that fluid is precluded from flowing between the splitter and the first fluid line thereby preparing the first fluid line for cleaning; and
maintaining the second controllable valve in an enabled mode such that fluid is continuously operable to flow between the splitter and the second fluid line during cleaning of the first fluid line.

16. A method as defined in claim 15, wherein the first controllable valve comprises a first fluid input port operable to accept fluid from the splitter, a first cleaning input port operable to accept a cleaning substance and a first output port fluidly coupled to first fluid line and wherein the second controllable valve comprises a second fluid input port operable to accept fluid from the splitter, a second cleaning input port operable to accept a cleaning substance and a second output port fluidly coupled to second fluid line, wherein the disabling act comprises:
closing the first fluid port and wherein the method comprises:
initiating the cleaning process by providing a substance to the first cleaning port for communication to the first fluid line.

17. A method as defined in claim 16, further comprising:
determining whether the cleaning process is complete; and
in response to determining that the cleaning process is complete, enabling the first controllable valve by opening the first fluid port thereby allowing communication of the fluid between the splitter and the first fluid line.

18. A method as defined in claim 16, wherein the substance comprises water.

19. A method as defined in claim 15, wherein:
the enabling act comprises applying a control gas to the first controllable valve and the second controllable valve; and
the disabling act comprises terminating supply of the control gas to the first controllable valve.

20. A method as defined in claim 15, wherein the fluid container is a tank valve.
